(19) United States
(12) Patent Application Publication
(10) Pub. No.: US 2014/0250695 A1
(43) Pub. Date: Sep. 11, 2014

(54) UTILITY KNIFE

(71) Applicant: MILWAUKEE ELECTRIC TOOL CORPORATION, Brookfield, WI (US)

(72) Inventors: Andrew G. Wagner, Lisbon, WI (US); Zachary LaPorte, Franklin, WI (US)

(73) Assignee: MILWAUKEE ELECTRIC TOOL CORPORATION, Brookfield, WI (US)

(21) Appl. No.: 13/788,619

(22) Filed: Mar. 7, 2013

(51) Int. Cl. B26B 5/00

(52) U.S. Cl. CPC B26B 5/003
USPC 30/162

(57) ABSTRACT

A utility knife includes a first handle portion and a second handle portion removably coupled to the first handle portion to define a housing. The first handle portion includes a first bore and the second handle portion includes a second bore. The utility knife also includes a blade carrier slidably received within housing and a blade removable coupled to the blade carrier for movement with the blade carrier relative to the housing. The utility knife also includes a double-lead fastener including a head, an unthreaded portion received within the first bore, and a double-lead threaded portion received within the second bore to couple the first handle portion and the second handle portion.

### FIELD OF THE INVENTION

The present invention relates to knives and more particularly to utility knives.

### BACKGROUND

Utility knives typically include a housing, a blade carrier supported by the housing, and a blade coupled to the blade carrier for movement with the blade carrier between an extended position and a retracted position relative to the housing. For some knives, the blade carrier is automatically returned to the refracted position when the knife is not in use.

### SUMMARY

The invention provides, in one aspect, a utility knife The utility knife includes a first handle portion and a second handle portion removably coupled to the first handle portion to define a housing. The first handle portion includes a first bore and the second handle portion includes a second bore. An aperture is formed through the housing at a front end of the housing. The utility knife also includes a blade carrier slidably received within the housing and a blade removable coupled to the blade carrier for movement with the blade carrier relative to the housing. The blade carrier includes a slot extending through the blade carrier. The utility knife also includes a projection located within the housing and engageable with the slot to limit movement of the blade carrier between an extended position, in which the blade projects from the aperture, and a retracted position, in which the blade is located within the housing. The utility knife also includes an actuator operably coupled to the blade carrier to facilitate movement of the blade carrier between the extended position and the retracted position. A biasing member is coupled to the blade carrier and configured to bias the blade carrier towards the retracted position. The utility knife also includes a spare blade holder including a leaf spring configured to secure at least one spare blade within the spare blade holder. The utility knife also includes a double-lead fastener including a head, an unthreaded portion received within the first bore, and a double-lead threaded portion received within the second bore to couple the first handle portion and the second handle portion. The unthreaded portion is retained within the first bore by the head and the double-lead threaded portion such that the double-lead fastener is retained with the first handle portion when the first handle portion is removed from the second handle portion.

The invention provides, in another aspect, a utility knife. The utility knife includes a first handle portion including a first bore and a second handle portion including a second bore. The second handle portion is removably coupled to the first handle portion to define a housing. The utility knife also includes a blade carrier received within housing and moveable between an extended position and a retracted position. A blade is coupled to the blade carrier for movement with the blade carrier relative to the housing. The utility knife also includes a double-lead fastener including a head and a double-lead threaded portion received within the second bore to couple the first handle portion and the second handle portion.

Other features and aspects of the invention will become apparent by consideration of the following detailed description and accompanying drawings.

### BRIEF DESCRIPTION OF THE DRAWINGS

FIG. 1 is a perspective view of a knife according to an embodiment of the invention.

FIG. 2 is a partially exploded view of the knife of FIG. 1.

FIG. 3 is a perspective view of a portion of the knife of FIG. 1.

FIG. 4 is a cross-sectional view of the knife of FIG. 1, taken along line 4-4 of FIG. 1.

FIG. 5 is a cross-sectional view of a fastener of the knife of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

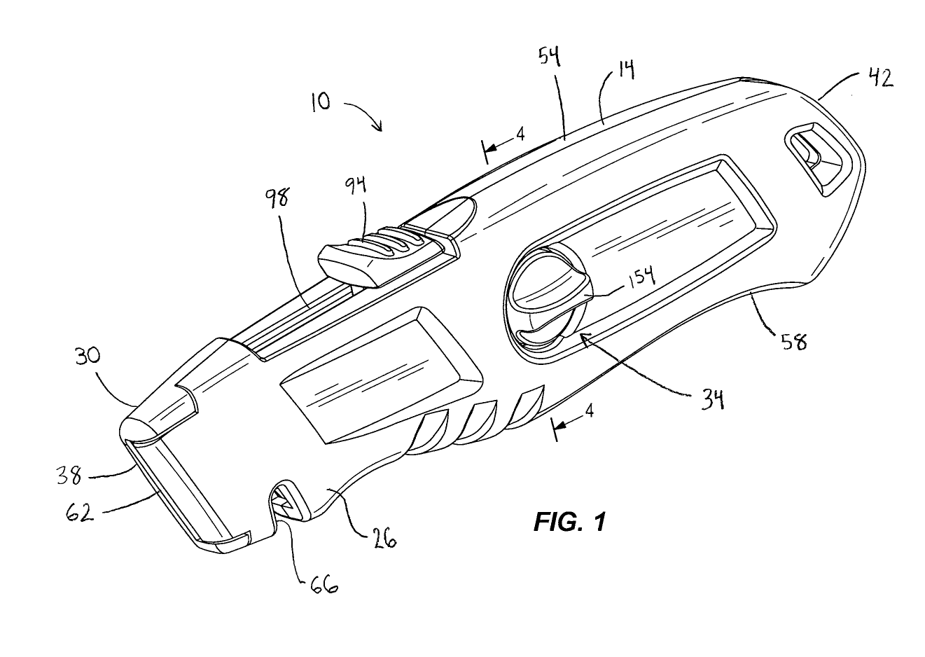

FIGS. 1-5 illustrate a knife 10 which is a utility knife 10 in the illustrated embodiment. The knife 10 includes a housing 14, a blade 18, and a blade carrier 22 that positions the blade 18 in a desired position relative to the housing 14.

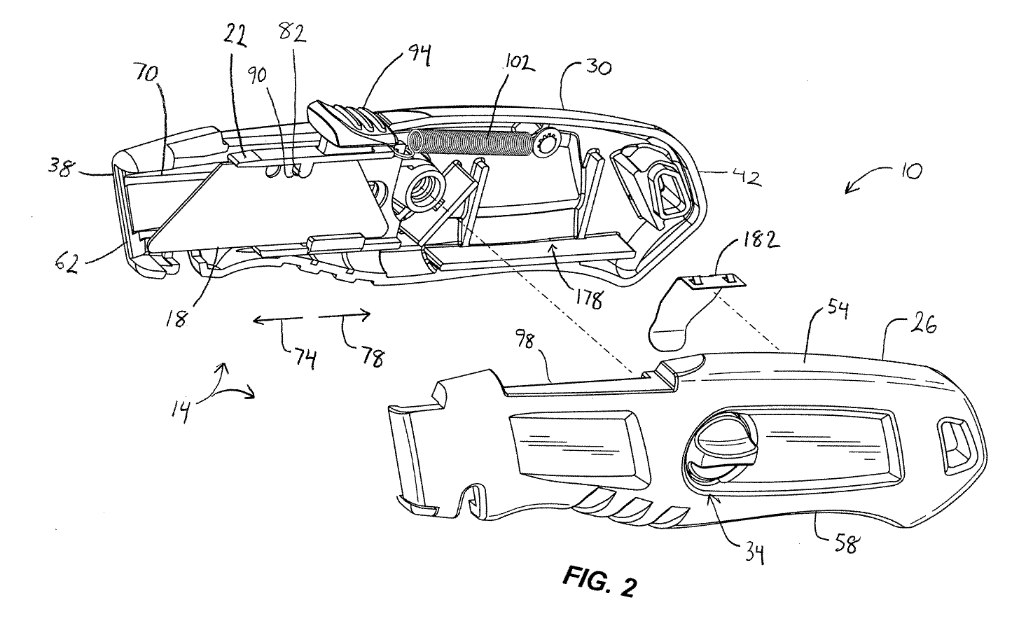

With reference to FIG. 1, the housing 14 includes a first handle portion 26 and a second handle portion 30 that cooperate to define the housing 14. The first handle portion 26 and the second handle portion 30 are removably coupled together by a fastener 34, which will be described in further detail below. The housing 14 includes a front end 38, a back end 42, sidewalls 46, 50 that extend from the front end 38 to the back end 42, and a top wall 54 and a bottom wall 58 that both extend from the front end 38 to the back end 42. The housing 14 is generally hollow and includes an aperture 62 in the front end 38 through which the blade 18 can extend. The housing 14 also includes a groove 66 or notch formed in the bottom wall 58, near the front end 38 of the housing 14. The groove 66 exposes a small portion of the blade 18 and allows a user of the knife 10 to perform certain cutting operations (e.g., stripping wire, cutting string) even when the blade 18 does not extend through the aperture 62 (FIG. 2).

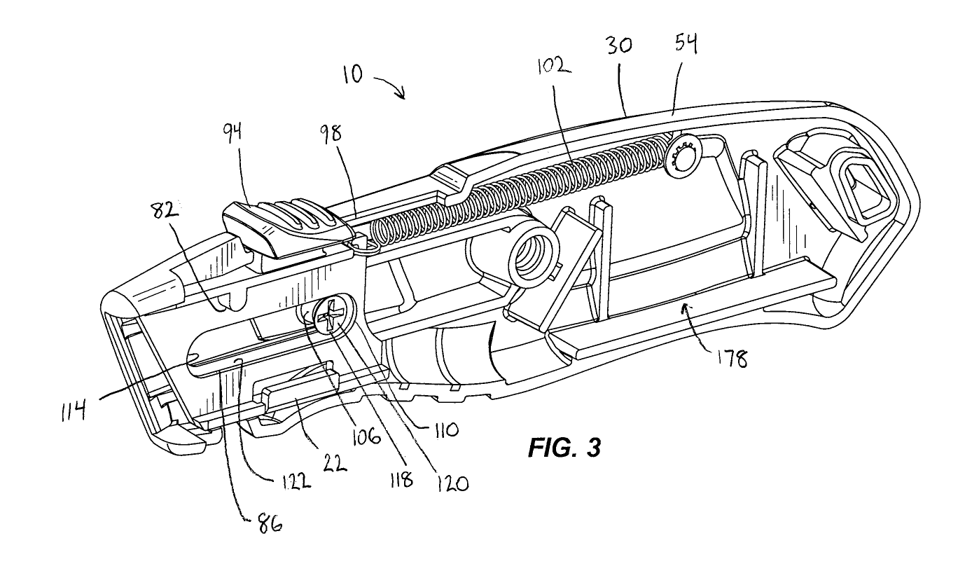

With reference to FIGS. 2 and 3, the interior of the housing 14 defines a track 70 that extends to the aperture 62 at the front end 38 of the housing 14. The blade carrier 22 is guided by the track 70 to slide with respect to the housing 14 in the direction of the arrows 74 and 78. The blade carrier 22 includes a projection 82 and an elongate slot 86 extending through the blade carrier 22 (FIG. 3). The projection 82 extends from the blade carrier 22 and through a notch 90 in the blade 18 to couple the blade 18 with the carrier 22 for movement with the carrier 22 along the track 70 (FIG. 2). An actuator 94 extends through a slot 98 formed in the top wall 54 of the housing 14 to provide the user with a place to grip the blade carrier 22 (e.g., with the user's thumb) to slide the blade carrier 22 with respect to the housing 14. In the illustrated embodiment, the actuator 94 is rigidly coupled to the blade carrier 22. In other embodiments, the actuator 94 can be operably coupled to the blade carrier 22 via a linkage or other suitable arrangement. The blade carrier 22 is continuously biased towards the rear of the housing 14 by a coil spring 102, such that the blade 18 is automatically retracted into the housing 14 if the actuator 94 is released from the forward position (FIG. 3).

With reference to FIG. 3, the second handle portion 30 includes a pin-like projection 106 that is received in the elongate slot 86 of the blade carrier 22. The projection 106 engages with a rear end 110 of the slot 86 when the blade carrier 22 is in the extended position to limit movement of the blade carrier 22 to the extended position. The projection 106 engages with a front end 114 of the slot 86 when the blade carrier 22 is in the retracted position to limit movement of the blade carrier 22 to the refracted position. Accordingly, the elongate slot 86 of the blade carrier 22 slides along the projection 106 as the blade carrier 22 moves between the extended position and the retracted position. In the illustrated embodiment, a projection 106 receives a threaded fastener 118 to retain the blade carrier 22 with the second handle portion 30 (e.g., when the first and second handle portions 26, 30 are disassembled). A head 120 of the threaded fastener 118 engages with a beveled periphery 122 of the elongated slot 86 to retain the blade carrier 22 while still permitting movement of the blade carrier 22 between the extended position and the retracted position.

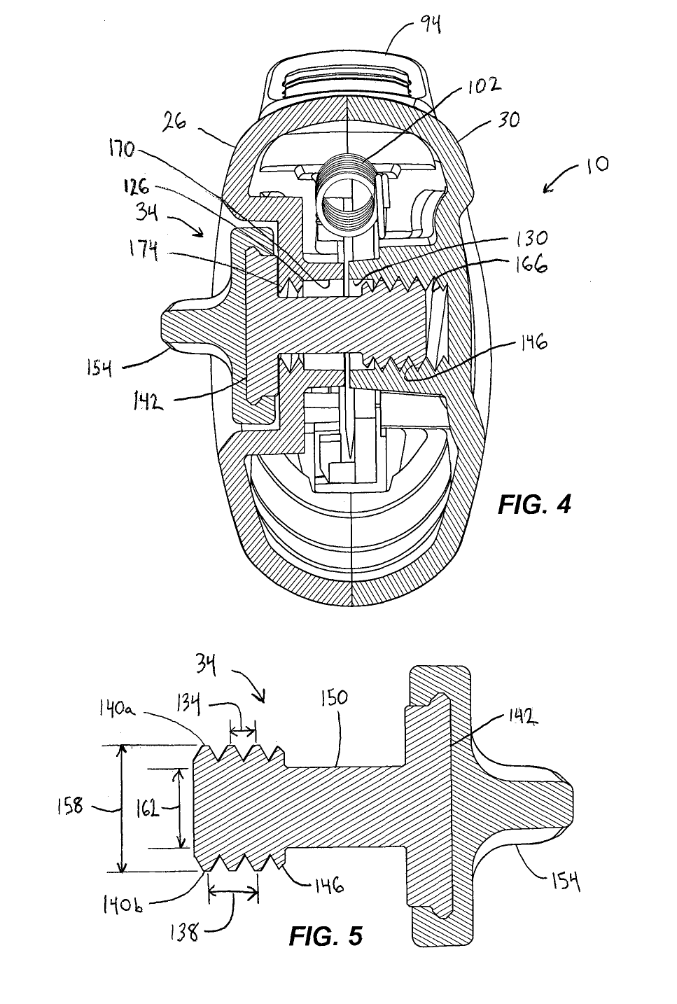

Referring to FIG. 4, the first handle portion 26 includes a first bore 126 and the second handle portion 30 includes a second bore 130. The first bore 126 and the second bore 130 are aligned when the first and second handle portions 26, 30 are assembled to receive the fastener 34 that holds the first and second handle portions 26, 30 together. Access to the blade 18 (e.g., for replacing the blade 18) is permitted by removing the fastener 34 and separating the two handle portions 26, 30 of the housing 14.

Illustrated in FIG. 5, the fastener 34 defines a pitch distance 134 (referred to hereafter as “pitch”) and a lead distance 138 (referred to hereafter as “lead”). The pitch 134 is the axial distance between adjacent crests of the fastener 34. The lead 138 is the axial distance that the fastener 34 is advanced for each complete rotation of the fastener 34. A conventional threaded fastener (not shown) includes a single thread wrapped helically around the fastener 34. The pitch and the lead of the conventional fastener are equal; therefore the conventional fastener advances an axial distance equal to the pitch for each complete rotation. In the illustrated embodiment, the fastener 34 is configured as a double-lead screw (also referred to as a double-start screw or a double-threaded screw). The illustrated fastener 34 includes two separate threads 140a, 140b offset 180 degrees and wrapped helically around the fastener 34. As such, the fastener 34 advances twice the pitch 134 per rotation (i.e., the lead 138 is twice the pitch 134), thereby requiring less rotation to couple or decouple the first and second handle portions 26, 30 than if a conventional fastener were used.

The illustrated fastener 34 includes a head 142, a threaded portion 146, and an unthreaded portion 150 between the head 142 and the threaded portion 146. The head 142 includes a gripping portion 154 to enable the user to rotate the fastener 34 without using a screwdriver or other tools. In the illustrated embodiment, the gripping portion 154 is formed around the head 142. In other embodiments, the gripping portion 154 can be integrally formed with the head 142 or machined from the head 142. The threaded portion 146 has a larger effective diameter 158 than a diameter 162 of the unthreaded portion 150. The threaded portion 146 is received in a threaded portion 166 of the second bore 130 when the first and second handle portions 26, 30 are coupled together (FIG. 4).

The first bore 126 includes an unthreaded portion 170 and a threaded portion 174. The threaded 174 portion has a slightly smaller diameter than the unthreaded portion 170. When the user loosens the fastener 34 to open or separate the handle portions 26, 30 (i.e., to change the blade 18), the threaded portion 146 of the fastener 34 is disengaged from the threaded portion 166 of the second bore 130. However, the fastener 34 remains attached to the first handle portion 26 because the head 142 of the fastener 34 and the threaded portion 146 of the fastener 34 are unable to pass freely through the threaded portion 174 of the first bore 126 when the handles portions 26, 30 are separated. Therefore, the fastener 34 does not easily fall out of the first bore 126 and become lost. If desired, the user could remove the fastener 34 from the first handle portion 26 by aligning the threads 146 of the fastener 34 with the threads 174 of the first bore 126 and by rotating the fastener 34 while pulling somewhat on the fastener 34. However, the above-described arrangement prevents the fastener 34 from unintentionally falling out of the bore 126 of the first handle portion 26 when the handle portions 26, 30 are separated (FIG. 2).

With reference to FIG. 2, the interior of the housing 14 defines a spare blade compartment 178 for storing at least one replacement blade (not shown). The spare blade compartment 178 is accessed by unscrewing the fastener 34 and removing one of the handle portions 26, 30, as described above. The replacement blade(s) are held snugly within the spare blade compartment 178 by a cantilevered leaf spring 182 supported by the first handle portion 26. The cantilevered leaf spring 182 exerts a biasing force against the replacement blades(s) within the spare blade compartment 178 when the first and second handle portion 26, 30 are assembled.

In operation, the user manipulates the actuator 94 to slide the blade carrier 22 from the retracted position to the extended position, against the biasing force of the spring 102. This exposes the blade 18 through the aperture 62 and enables the user to perform a cutting operation. When the user releases the actuator 94, the spring 102 causes the blade carrier 22 to move to the retracted position in the direction of arrow 78, withdrawing the blade 18 inside the housing 14. A small portion of the blade 18 remains exposed through the notch 66 in the housing 14, allowing the user to perform certain cutting operations, such as wire stripping.

To replace the blade 18, the user grips the gripping portion 154 of the fastener 34 and rotates the fastener 34 in a first direction (i.e., counterclockwise). Because the fastener 34 is configured as a double-lead screw, a relatively small degree of rotation is required to disengage the threaded portion 146 of the fastener 34 from the threaded portion 166 second bore 130. Once the fastener 34 is disengaged from the second handle portion 30, the user can remove the first handle portion 26 to gain access to the blade 18 and the spare blade compartment 178 in order to replace the blade 18. The fastener 34 is retained within the first bore 126 of the first handle portion 26 by the head 142 and the threaded portion 146 of the fastener 34. This prevents the user from misplacing the fastener 34. If desired, the user can remove the fastener 34 from the first handle portion 26 by aligning the threads 146 of the fastener 34 with the threads 174 of the first bore 126 and by rotating the fastener 34 while pulling somewhat on the fastener 34. To reassemble the utility knife 10, the user aligns the first bore 126 of the first handle portion 26 with the second bore 130 of the second handle portion 30, then rotates the fastener 34 in a second direction (i.e., clockwise). As mentioned above, because the fastener 34 is configured as a double-lead screw, only a relatively small degree of rotation is required to secure the first and second handle portions 26, 30 together.

Various features of the invention are set forth in the following claims.

What is claimed is:

1. A utility knife comprising:
a first handle portion including a first bore;
a second handle portion removably coupled to the first handle portion to define a housing, the second handle portion including a second bore;
an aperture formed through the housing at a front end of the housing;
a blade carrier slidably received within housing, the blade carrier including a slot extending through the blade carrier;
a blade removably coupled to the blade carrier for movement with the blade carrier relative to the housing;
a projection located within the housing and engageable with the slot to limit movement of the blade carrier between an extended position in which the blade projects from the aperture and a retracted position in which the blade is located within the housing;
an actuator operably coupled to the blade carrier to facilitate movement of the blade carrier between the extended position and the retracted position;
a biasing member coupled to the blade carrier and configured to bias the blade carrier towards the refracted position;
a spare blade holder configured to secure at least one spare blade within the spare blade holder; and
a double-lead fastener including a head, an unthreaded portion received within the first bore, and a double-lead threaded portion received within the second bore to couple the first handle portion and the second handle portion,
wherein the unthreaded portion is retained within the first bore by the head and the double-lead threaded portion such that the double-lead fastener is retained with the first handle portion when the first handle portion is removed from the second handle portion.

2. The utility knife of claim 1, wherein the housing includes a notch exposing a portion of the blade when the blade carrier is in the retracted position to enable a user of the utility knife to perform a cutting operation when the blade carrier is in the retracted position.

3. The utility knife of claim 1, wherein the first bore includes threads corresponding with the double-lead threaded portion of the double-lead fastener to permit removal of the double-lead fastener from the first bore.

4. The utility knife of claim 1, wherein the double-lead fastener is configured as a thumb screw and includes a gripping surface to facilitate rotation of the double-lead fastener relative to the housing.

5. The utility knife of claim 1, wherein the spare blade holder includes a leaf spring supported by the housing, the leaf spring configured to exert a force on the at least one spare blade to secure the at least one spare blade within the spare blade holder.

6. A utility knife comprising:
a first handle portion including a first bore;
a second handle portion removably coupled to the first handle portion to define a housing, the second handle portion including a second bore;
a blade carrier received within housing and moveable between an extended position and a retracted position;
a blade coupled to the blade carrier for movement with the blade carrier relative to the housing; and
a double-lead fastener including a head and a double-lead threaded portion received within the second bore to couple the first handle portion and the second handle portion.

7. The utility knife of claim 6, wherein the double-lead fastener further includes an unthreaded portion between the head and the double-lead threaded portion.

8. The utility knife of claim 7, wherein the unthreaded portion is retained within the first bore by the head and the double-lead threaded portion such that the double-lead fastener is retained with the first handle portion when the first handle portion is removed from the second handle portion.

9. The utility knife of claim 6, wherein the first bore includes threads corresponding with the double-lead threaded portion of the double-lead fastener to permit removal of the double-lead fastener from the first bore.

10. The utility knife of claim 6, wherein the blade carrier includes a slot that extends through the blade carrier.

11. The utility knife of claim 10, further comprising a projection located within the housing and engageable with the slot to limit movement of the blade carrier between the extended position and the retracted position.

12. The utility knife of claim 11, further comprising a fastener slidably coupling the blade carrier to the projection to retain the blade carrier with second handle portion when the first handle portion is removed from the second handle portion.

13. The utility knife of claim 6, further comprising an actuator operably coupled to the blade carrier to move the blade carrier between the extended position and the retracted position.

14. The utility knife of claim 13, wherein the actuator is rigidly coupled to the blade carrier to move with the blade carrier between the extended position and the retracted position.

15. The utility knife of claim 6, further comprising a biasing member coupled to the blade carrier and configured to bias the blade carrier towards the refracted position.

16. The utility knife of claim 15, wherein the biasing member is a coil spring.

17. The utility knife of claim 6, further comprising a spare blade holder configured to secure at least one spare blade within the spare blade holder.

18. The utility knife of claim 17, wherein the spare blade holder includes a leaf spring supported by the housing, the leaf spring configured to exert a force on the at least one spare blade to secure the at least one spare blade within the spare blade holder.

19. The utility knife of claim 6, wherein the housing includes a notch exposing a portion of the blade when the blade carrier is in the retracted position to enable a user of the utility knife to perform a cutting operation when the blade carrier is in the retracted position.

20. The utility knife of claim 6, wherein the double-lead fastener is configured as a thumb screw and includes a gripping surface to facilitate rotation of the double-lead fastener relative to the housing.
